(19) United States
(12) Patent Application Publication
(10) Pub. No.: US 2009/0325608 A1
(43) Pub. Date: Dec. 31, 2009

(54) METHODS AND SYSTEMS FOR MULTI-MODE PAGING

(75) Inventors: Steven Cheng, San Diego, CA (US); Tom Chin, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/163,143

(22) Filed: Jun. 27, 2008

(51) Int. Cl. H04Q 7/20

(52) U.S. Cl. 455/458

(57) ABSTRACT

Methods and apparatus for communicating with a multimode mobile station supporting multiple radio access technologies (RATs) are provided. For certain embodiments, when a paging request is received via a first RAT network, paging requests may be broadcast on all RATs supported by the mobile device. As a result, the mobile device may receive the paging request regardless of which RAT it used for a current network connection.

### TECHNICAL FIELD

Certain embodiments of the present disclosure generally relate to wireless communication and, more particularly, to communicating with mobile devices that support multiple radio access technologies.

### BACKGROUND

OFDM and OFDMA wireless communication systems under IEEE 802.16 use a network of base stations to communicate with wireless devices (i.e., mobile stations) registered for services in the systems based on the orthogonality of frequencies of multiple subcarriers and can be implemented to achieve a number of technical advantages for wideband wireless communications, such as resistance to multipath fading and interference. Each base station (BS) emits and receives radio frequency (RF) signals that convey data to and from the mobile stations (MS).

In order to expand the services available to subscribers, some MSs support communications with multiple radio access technologies (RATs). For example, a dual-mode MS may support WiMAX for broadband data services and code division multiple access (CDMA) for voice services.

Unfortunately, in conventional systems, inefficient switching between the two networks may cause a reduction in throughput on either service

### SUMMARY OF THE DISCLOSURE

Certain embodiments provide a method for wireless communications by a multi-mode mobile station. The method generally includes transmitting a list of supported radio access technologies (RATs) supported by the mobile station, establishing a connection with a first network via a first one of the RATs supported by the mobile station, receiving, via the first connection, a multi-mode paging message indicating a paging request for the mobile station detected on a second network that supports a second one of the RATs supported by the mobile station, and in response to the multi-mode paging message, establishing a connection with the second network via the second one of the RATs.

Certain embodiments provide a method for wireless communications with a multi-mode mobile station. The method generally includes receiving a list of at least first and second radio access technologies (RATs) supported by the mobile station and in response to detecting a paging request targeting the mobile station via a first one of the supported RATs, broadcasting multi-mode paging messages to the mobile station via the first and second RATs.

Certain embodiments provide a multi-mode mobile station. The mobile station generally includes logic for transmitting a list of supported radio access technologies (RATs) supported by the mobile station, logic for establishing a connection with a first network via a first one of the RATs supported by the mobile station, logic for receiving, via the first connection, a multi-mode paging message indicating a paging request for the mobile station detected on a second network that supports a second one of the RATs supported by the mobile station, and logic for establishing a connection with the second network via the second one of the RATs in response to the multi-mode paging message.

Certain embodiments provide a device for wireless communications with a multi-mode mobile station. The device generally includes logic for receiving a list of at least first and second radio access technologies (RATs) supported by the mobile station and logic for broadcasting multi-mode paging messages to the mobile station via the first and second RATs in response to detecting a paging request targeting the mobile station via a first one of the supported RATs.

Certain embodiments provide an apparatus for multi-mode wireless communications. The apparatus generally includes means for transmitting a list of supported radio access technologies (RATs) supported by the mobile station, means for establishing a connection with a first network via a first one of the RATs supported by the mobile station, means for receiving, via the first connection, a multi-mode paging message indicating a paging request for the mobile station detected on a second network that supports a second one of the RATs supported by the mobile station, and means for establishing a connection with the second network via the second one of the RATs in response to the multi-mode paging message.

Certain embodiments provide a device for wireless communications with a multi-mode mobile station. The device generally includes means for receiving a list of at least first and second radio access technologies (RATs) supported by the mobile station and means for broadcasting multi-mode paging messages to the mobile station via the first and second RATs in response to detecting a paging request targeting the mobile station via a first one of the supported RATs.

Certain embodiments provide a computer-readable medium containing a program. When executed by a processor of a multi-mode mobile station, the program performs operations generally including transmitting a list of supported radio access technologies (RATs) supported by the mobile station, establishing a connection with a first network via a first one of the RATs supported by the mobile station, receiving, via the first connection, a multi-mode paging message indicating a paging request for the mobile station detected on a second network that supports a second one of the RATs supported by the mobile station, and in response to the multi-mode paging message, establishing a connection with the second network via the second one of the RATs.

Certain embodiments provide a computer-readable medium containing a program for wireless communications with a multi-mode mobile station. When executed by a processor, the program performs operations generally including receiving a list of at least first and second radio access technologies (RATs) supported by the mobile station and in response to detecting a paging request targeting the mobile station via a first one of the supported RATs, broadcasting multi-mode paging messages to the mobile station via the first and second RATs.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology, in accordance with certain embodiments of the present disclosure.

FIG. 4 illustrates an example system in which a multi-mode mobile station support a plurality of radio access technologies (RATs), in accordance with certain embodiments of the present disclosure.

FIGS. 5A and 5B illustrate example paging schedules of different RATs and a unifiled multi-mode paging schedule, respectively, in accordance with certain embodiments of the present disclosure.

FIG. 6 illustrates example operations that may be performed by a multi-mode mobile station that supports a multi-mode paging request, in accordance with certain embodiments of the present disclosure.

FIG. 6A is a block diagram of example components capable of performing the operations shown in FIG. 6.

FIG. 7 illustrates example operations to perform multi-mode paging, in accordance with embodiments of the present disclosure.

FIG. 7A is a block diagram of example components capable of performing the operations shown in FIG. 7.

FIGS. 8A-8E illustrate example communications for multi-mode paging, in accordance with certain embodiments of the present disclosure.

FIGS. 9A-9C illustrate example communications for multi-mode paging based on network congestion, in accordance with certain embodiments of the present disclosure.

### DETAILED DESCRIPTION

Certain embodiments of the present disclosure allow a multi-mode mobile device that supports communications via a plurality of radio access technologies (RATs) to receive a multi-mode page request on one RAT indicating traffic destined for the MS on another RAT. Through the use of unified multi-mode paging, certain embodiments of the present disclosure may allow a first RAT network, through which a multi-mode mobile station has an active connection, to serve as a message tunnel for messages from other RAT networks. For example, multi-mode paging may allow a mobile device with an active WiMAX connection to receive a CDMA paging message, without having to switch over the CDMA network.

As a result, the multi-mode device may be able to detect traffic on different RATs without having to switch and listen to the paging channel of each of the different RATs. By reducing or eliminating the need to switch between RATs to detect paging messages, data throughput may be improved by reducing the number of interruptions in user traffic. Reducing or eliminating the need to switch between RATs to detect paging messages may also reduce power consumption.

### Exemplary Wireless Communication System

The methods and apparatus of the present disclosure may be utilized in a broadband wireless communication system. As used herein, the term “broadband wireless” generally refers to technology that may provide any combination of wireless services, such as voice, Internet and/or data network access over a given area.

WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX offers the full mobility of cellular networks at broadband speeds.

Mobile WiMAX is based on OFDM (orthogonal frequency-division multiplexing) and OFDMA (orthogonal frequency division multiple access) technology. OFDM is a digital multi-carrier modulation technique that has recently found wide adoption in a variety of high-data-rate communication systems. With OFDM, a transmit bit stream is divided into multiple lower-rate substreams. Each substream is modulated with one of multiple orthogonal subcarriers and sent over one of a plurality of parallel subchannels. OFDMA is a multiple access technique in which users are assigned subcarriers in different time slots. OFDMA is a flexible multiple-access technique that can accommodate many users with widely varying applications, data rates, and quality of service requirements.

The rapid growth in wireless internets and communications has led to an increasing demand for high data rate in the field of wireless communications services. OFDM/OFDMA systems are today regarded as one of the most promising research areas and as a key technology for the next generation of wireless communications. This is due to the fact that OFDM/OFDMA modulation schemes can provide many advantages such as modulation efficiency, spectrum efficiency, flexibility, and strong multipath immunity over conventional single carrier modulation schemes.

IEEE 802.16x is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

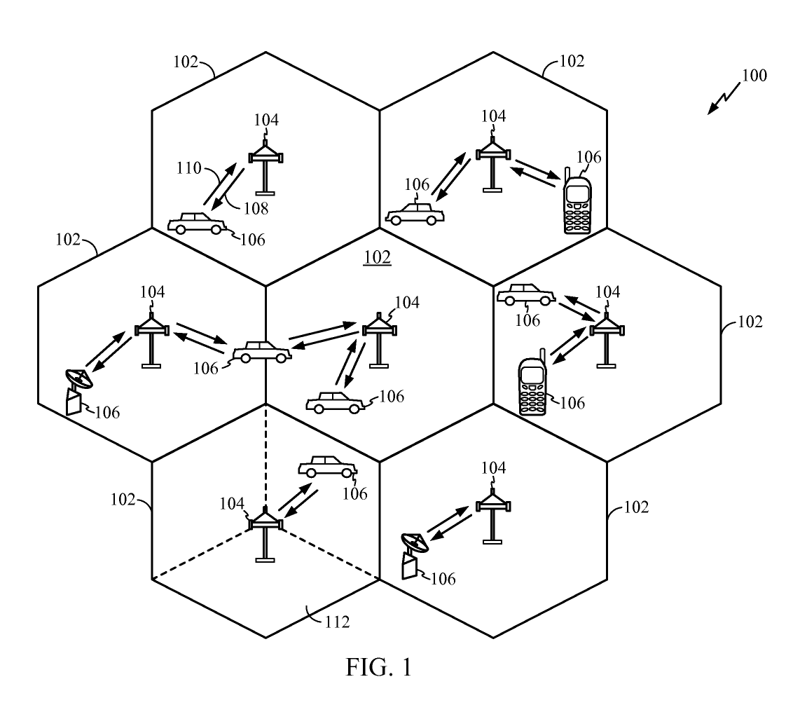

FIG. 1 illustrates an example of a wireless communication system 100 in which embodiments of the present invention may be employed. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers, etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

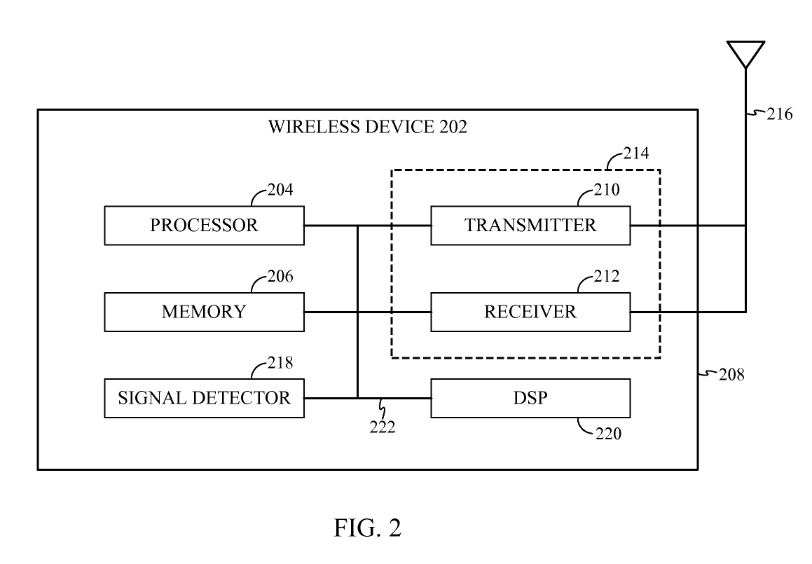

FIG. 2 illustrates various components that may be utilized in a wireless device 202 that may be employed within the wireless communication system 100. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier, power spectral density and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

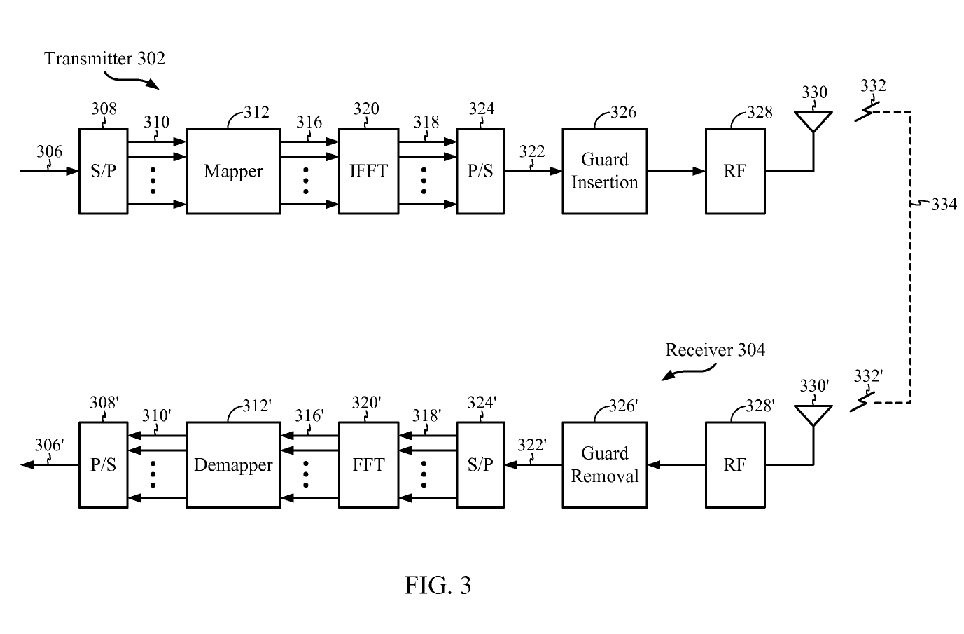

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to N_{cp} (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless device 202 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312 thereby outputting N parallel data streams 310′. A P/S converter 308′ may combine the N parallel data streams 310′ into a single data stream 306′. Ideally, this data stream 306′ corresponds to the data 306 that was provided as input to the transmitter 302. Note that elements 308′, 310′, 312′, 316′, 320′, 318′ and 324′ may all be found on a in a baseband processor 340′.

### Exemplary Power Saving Multi-Mode Techniques

As stated above, WiMAX wireless communication systems based on the IEEE 802.16 standard use a network of base stations mounted to service towers to communicate with wireless devices (i.e., mobile stations). Each base station (BS) emits and receives radio frequency (RF) signals that convey data to and from the mobile stations (MS) (e.g. cell phones, laptop computers, etc.). Similarly, other radio access technologies (RATs) use a network of base stations to communicate with one or more wireless devices. For example, the Universal Mobile Telecommunication System (UMTS), Global System for Mobile communications (GSM), and Ultra Mobile Broadband (UMB) technologies may all employ a plurality of BSs to receive and transmit RF signals that convey data to and from MSs. Since a single service tower may physically support a plurality of base stations for a variety of RATs, a given geographic area may be within the coverage area of more than one radio access technology

Accordingly, an MS may be configured to communicate with a plurality of RATs (such an MS is referred to herein as a multi-mode MS). Since a multi-mode MS typically maintains an active connection with a single RAT at a time, the MS may be idle with respect to other RATs supported by the MS. Consequently, in conventional systems, in order to detect traffic on other networks, the MS may periodically switch over and listen to the paging channels for each supported RAT. In an effort to ensure paging messages are not missed, the MS will typically switch over and listen to the paging channel of each RAT based on a paging schedule of each RAT. Unfortunately, switching between various RATs to listen for paging requests results in a waste of power if a paging request is not present. Further, data throughput may be reduced while the MS switches among the various RATs listening for paging requests.

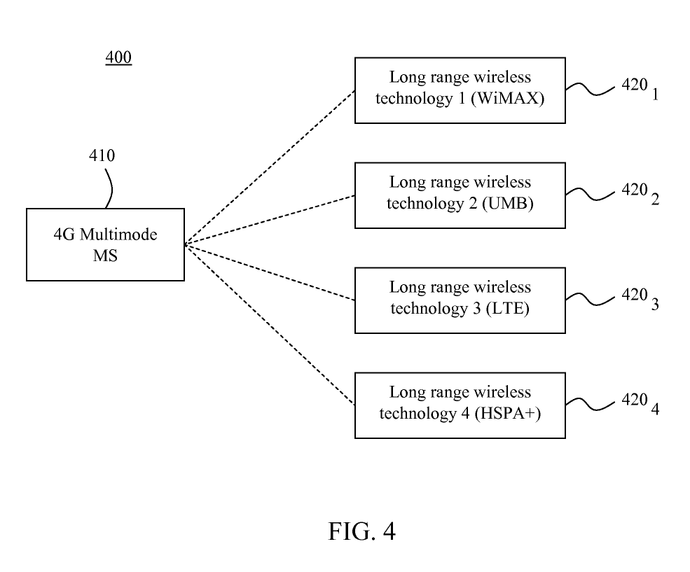

FIG. 4 illustrates a system 400 in which a multi-mode MS 410 may operate in a geographic area that is serviced by a plurality of long-range, wireless RATs 420₁₋₄. In the illustrated example, the multi-mode MS may access a network through a Worldwide Interoperability for Microwave Access (WiMAX) service 420₁, an Ultra Mobile Broadband (UMB) service 420₂, Long Term Evolution (LTE) service 420₃, an Evolved High-Speed Packet Access (HSPA+) service 420₄, and/or any other type of long or short range RAT.

As previously described, while the MS may be limited to an active connection with a single RAT at any time, each RAT may have its own paging schedule. Thus, while the MS is actively connected to one RAT, it may be idle with respect to the other RATs. Because each RAT may maintain independent paging schedules in which the MS is notified of traffic destined for the MS on that RAT, in conventional systems, an MS may frequently switch between RATs in order to listen to paging messages, which may reduce overall data throughput and increase overall power consumption.

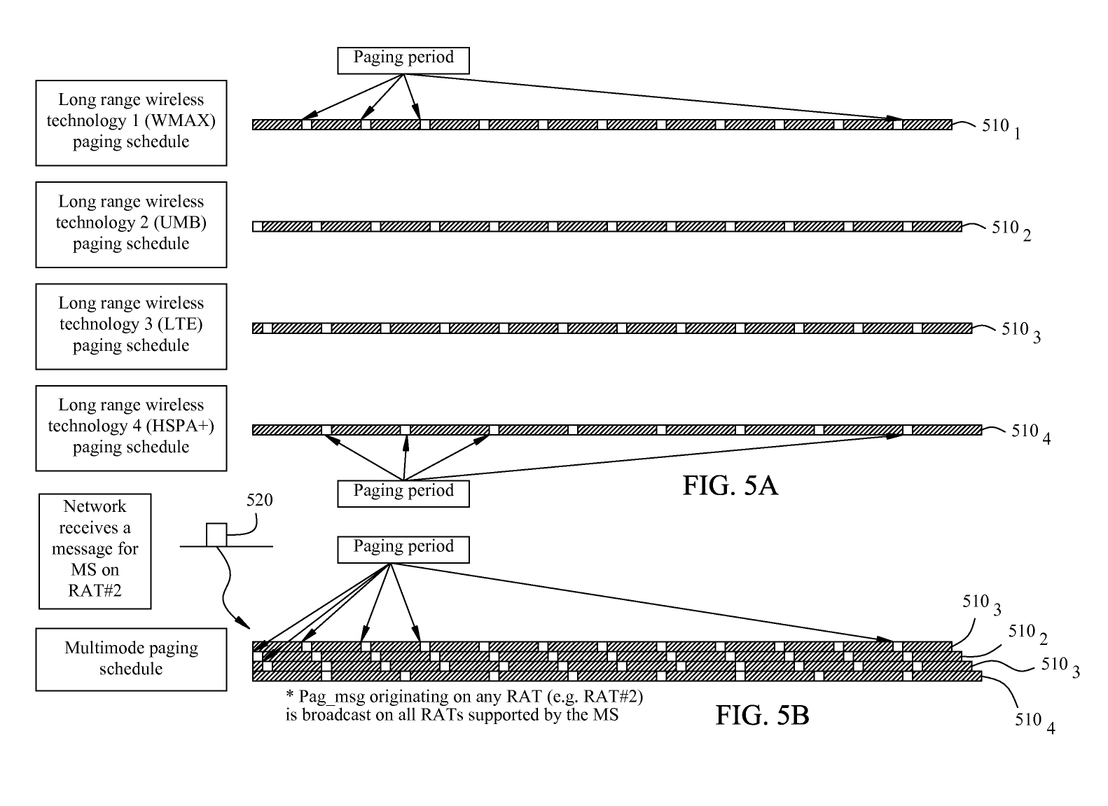

FIG. 5A illustrates example paging schedules 510₁₋₄ for the RATs 420₁₋₄ shown in FIG. 4. As illustrated, the paging schedules for the different RATs may have different periods, which may require the multi-mode MS to frequently switch between RATs in an effort to ensure a paging message is not missed.

Certain embodiments of the present disclosure, however, provide for multi-mode paging that allows a multi-mode MS to monitor for paging messages from multiple RATs while listening to a single RAT base station. As a result, multi-mode paging may allow paging messages from other RATs to be detected, without the reduction in data throughput or increase in power consumption incurred in conventional systems that require switching over to the other RATs to listen for paging messages.

As illustrated in FIG. 5B, multi-mode paging may be accomplished in a multi-RAT network by broadcasting a paging request on all RATs supported by the multi-mode MS 410 when a paging request is received on a single RAT. For example, assuming a multi-mode MS that supports four RATs, in response to receiving a paging message 520 for a first RAT, the multi-mode network may broadcast paging messages 510′₁₋₄ on all RATs supported by the MS. Thus, the MS may receive the paging message regardless of which RAT has the active connection.

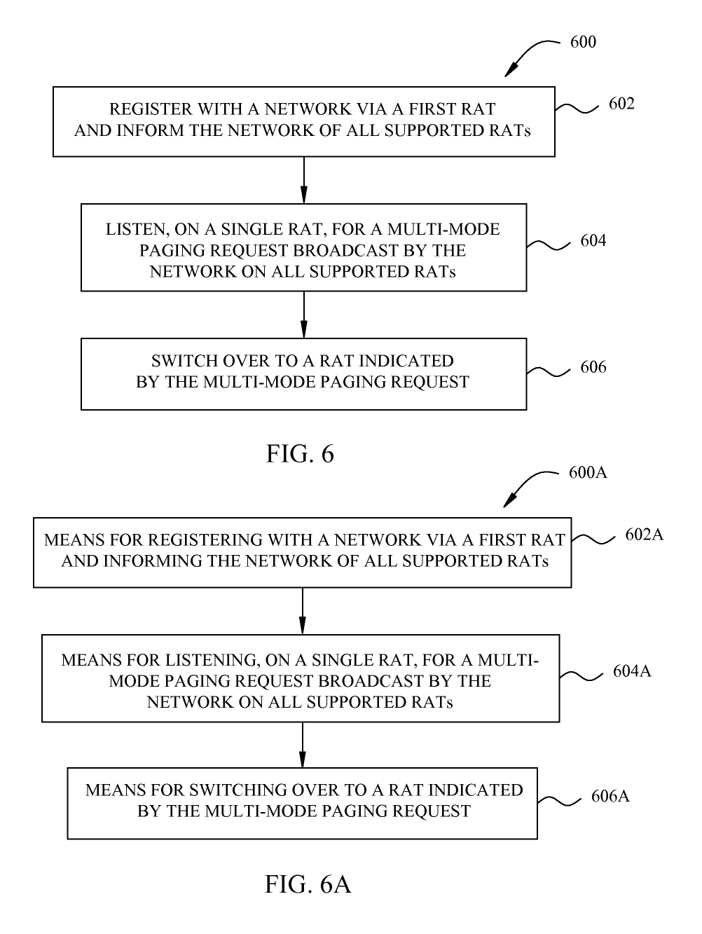

FIG. 6 illustrates example operations 600 a multi-mode MS may perform in order to enable and utilize multi-mode paging, in accordance with certain embodiments of the present disclosure.

The operations begin, at 602, by registering with a network via a first RAT and informing the network of the RATs supported by the MS. For example, during the channel setup process, the MS may inform the network of all the RATs it supports. As a result, when the network receives a paging request on one RAT, it may broadcast paging requests on all the RATs that the mobile device can support.

Having communicated the RATs supported by the MS to the network, at 604, the MS may listen on a single RAT, for a multi-mode paging request broadcast by the network on multiple RATs supported by the MS. Upon receipt of a multi-mode paging request, the MS may switch over to the RAT indicated by the multi-mode paging request, at 606.

For certain embodiments, standards governing how MSs communicate with networks via particular RATs may need to be modified, for example, to allow the MS to perform one or more of the operations 600 shown in FIG. 6. For certain embodiments, existing message formats utilized in certain RAT standards may be utilized to broadcast multi-mode paging messages, for example, allowing one RAT to act as a tunnel for paging messages from other RATs. On the network side, base stations and other interface logic may be configured to allow the RATs supported by an MS to be propagated through the network. For example, when an MS registers with the network via one RAT, the components supporting that RAT may communicate the set of RATs supported by the MS to components of the other RATs.

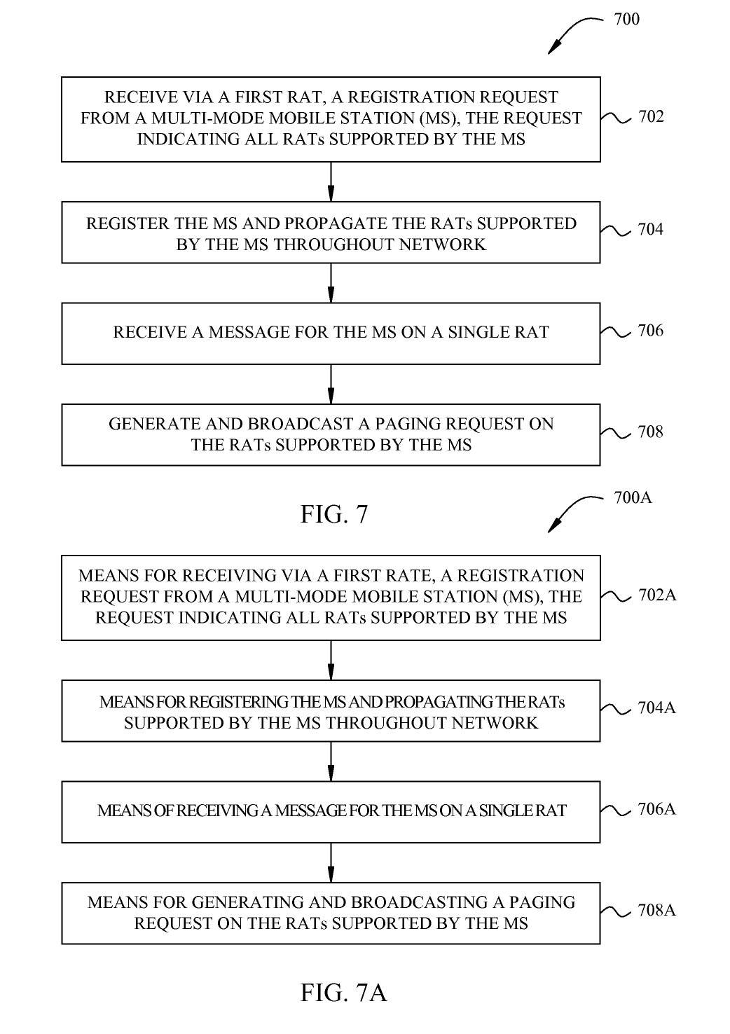

FIG. 7 illustrates example operations 700 that may be performed by components of a multi-RAT network to enable and utilize multi-mode paging, in accordance with certain embodiments of the present disclosure.

The operations begin, at 702, by receiving a registration request from a multi-mode MS, via a first RAT. The registration request may include an indication of the RATs supported by the MS. At 704, the MS may be registered and an indication of the RATs supported by the MS may be propagated through the network. For example, a base station of the RAT receiving the registration request may communicate the RATs supported by the MS to base stations of the other supported RATs.

When the network receives a message (data traffic, a voice phone call, etc.) targeting the MS on one of the RATs, at 706, paging requests may be broadcast on all RATs supported by the MS, at 708. As described above, the multi-mode paging request may include information indicating through which RAT incoming voice or data is available. Thus, the MS should hear the paging request, regardless of which RAT the MS is connected to.

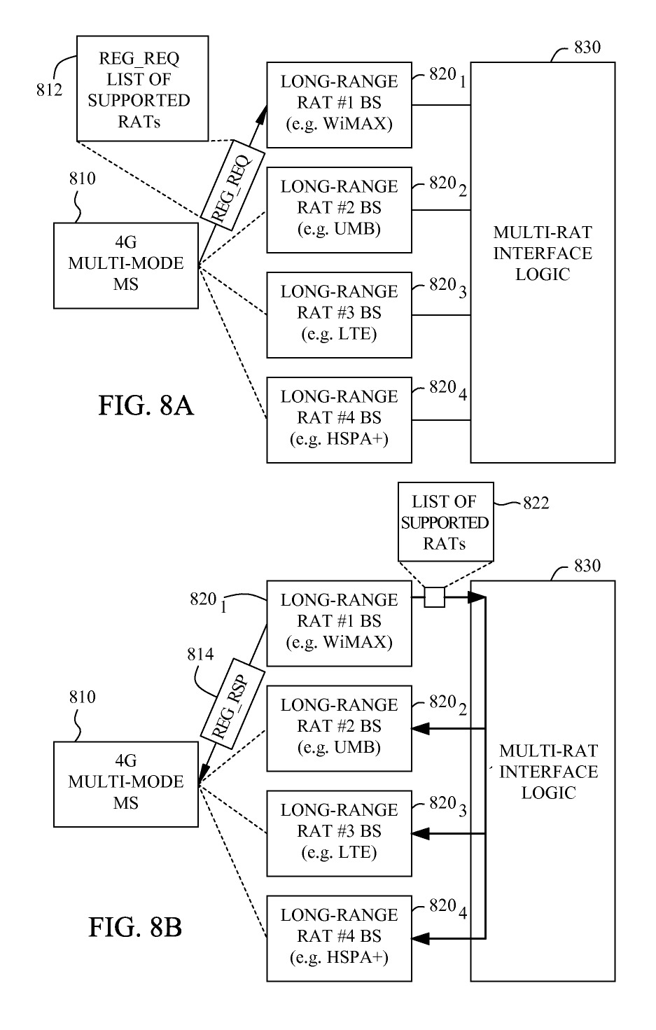

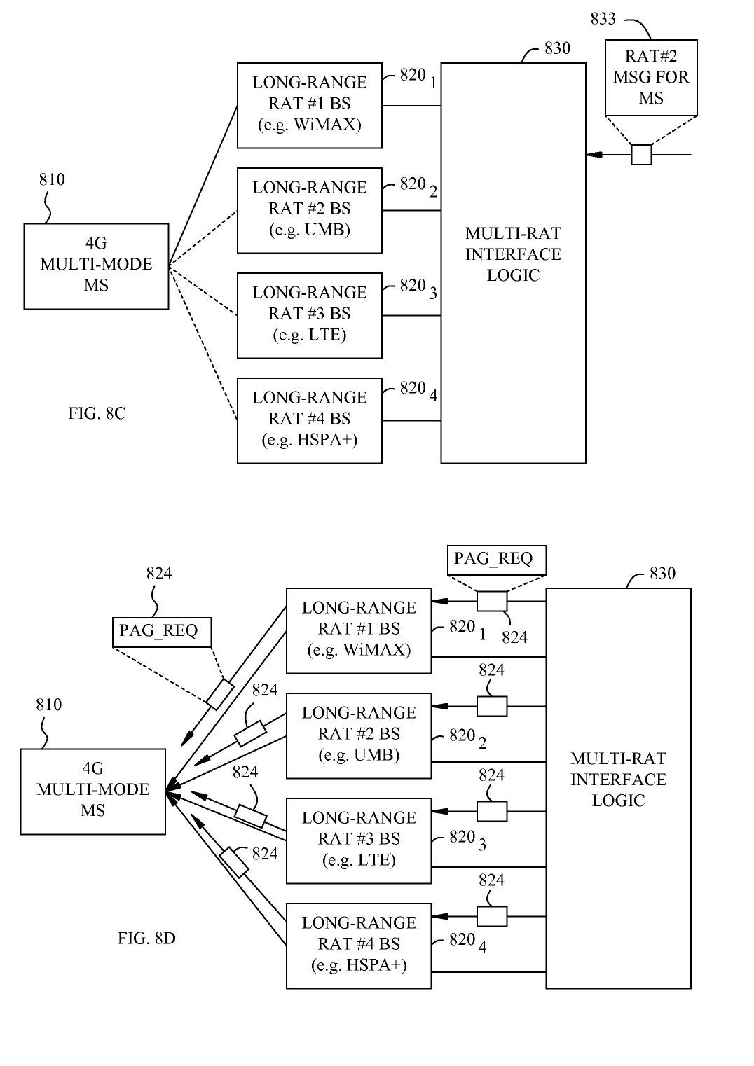

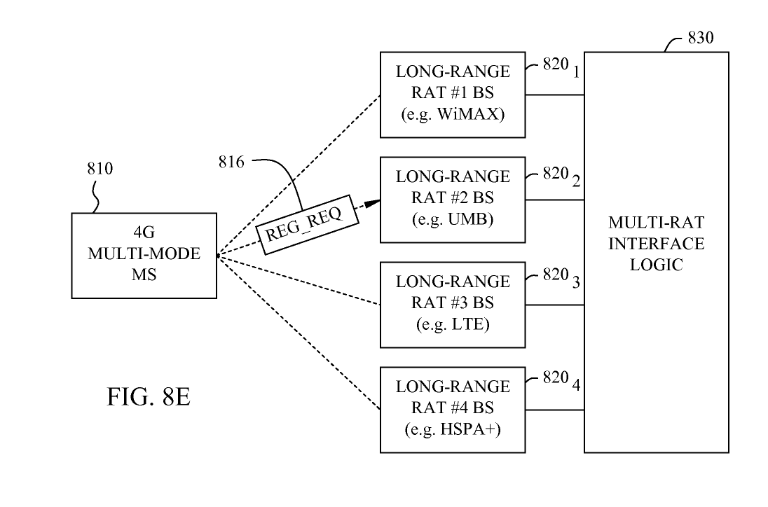

FIGS. 8A-8E illustrate example communications between a multimode MS 810 and components of a multi-RAT network, in accordance with the example operations shown in FIGS. 6 and 7. As illustrated, the multi-RAT network may include a plurality of base stations 820₁₋₄ supporting a corresponding variety of RATs, and multi-RAT interface logic 830 that allows information to be exchanged between the BSs of the multiple RATs. The multi-RAT interface logic 830 may include any suitable combination of components, such as base stations, mobile switching centers (MSCs), access service network gateway (ASN-GW) devices, and/or any other suitable type components that may serve as an interface between components of different RATs.

As illustrated in FIG. 8A, the MS 810 may register with the network, via a first RAT, by sending a registration request 812 to a first RAT BS, illustratively a WiMAX BS 820₁. As described above, the registration request 812 may include a list of the various RATs supported by the MS 810, for example, list 822.

In response to the registration request 812, the BS 820₁ of the first RAT may send a registration response 814 to the MS 810, as illustrated in FIG. 8B, and an active WiMAX connection may be established (as indicated by the solid line between the MS 810 and the WiMAX BS 820₁). Additionally, the BS 820₁ may communicate with the interface logic 830 in order to propagate the list 822 of RATs supported by the MS 810 to their corresponding BSs. After registering the MS 810 and propagating the list of RATs supported by the MS 810, the network may engage in conventional operations with the MS.

While the MS 810 maintains the active connection with the first RAT (e.g., a WiMAX connection), the network may receive a message 832 destined for the MS 810 from a second RAT, as illustrated in FIG. 8C. For example, the message 832 may be a page request from an MSC of a CDMA network indicating a voice call targeting the MS 810.

While the MS 810 may not have an active connection to the second RAT, the network may still be able to notify the MS 810 of the message 832. For example, as illustrated in FIG. 8D, paging requests 824 may be broadcast on each of the RATs supported by the MS 810. Thus, in the illustrated example, the MS 810 may receive the paging request 824 via its WiMAX connection, without having to switch over to listen to the paging channels of the other RATs.

The paging request 824, received via the first RAT connection, may include an indication of the second RAT corresponding to the paging request that prompted the multi-mode paging request. Therefore, as illustrated in FIG. 8E, in response to the paging request 824 being received on the first RAT, the MS 810 may initiate operations (e.g., sending a registration request 816) to establish a connection with the second RAT network (e.g., to receive the CDMA call).

For certain embodiments, multi-mode broadcast messages may also be used to help control network flow based on various network conditions. For example, if one RAT has a network congestion problem, the network may inform the MS of a preferred (e.g., less congested) RAT the MS should switch to listen to for paging messages. When the mobile device is paged, it may respond on the less congested network. By controlling the RAT a MS uses and responds on, network operators may be able to balance traffic to/from the MS.

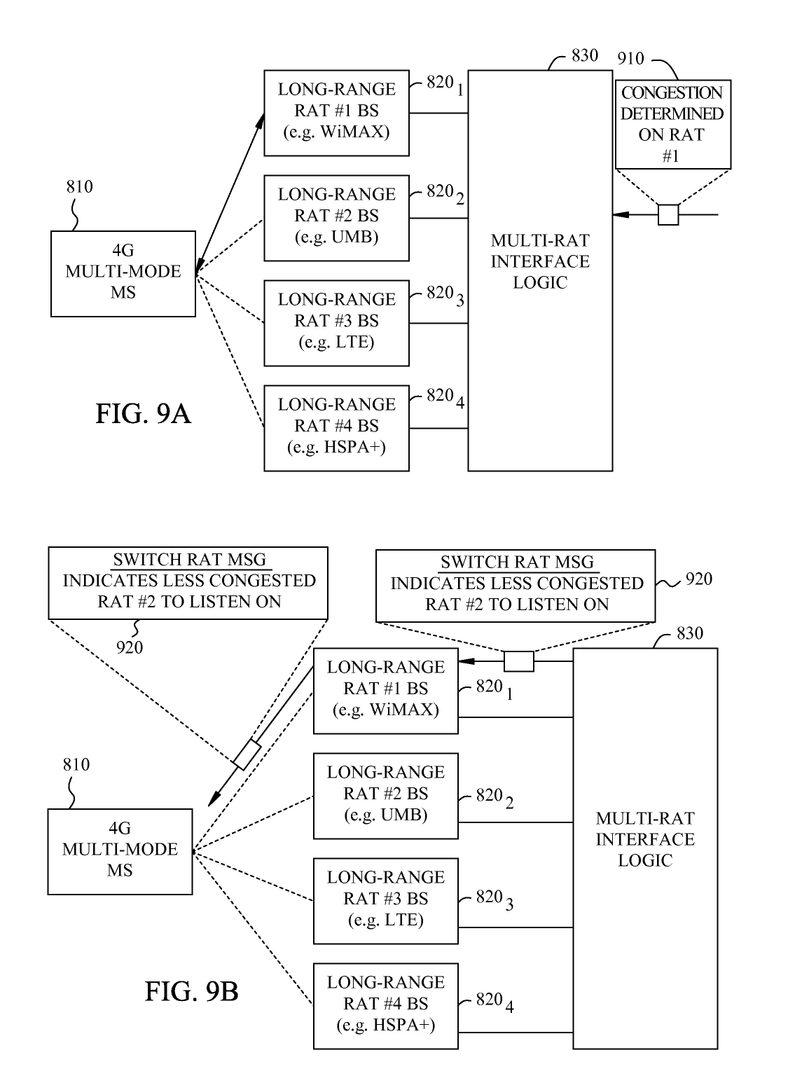

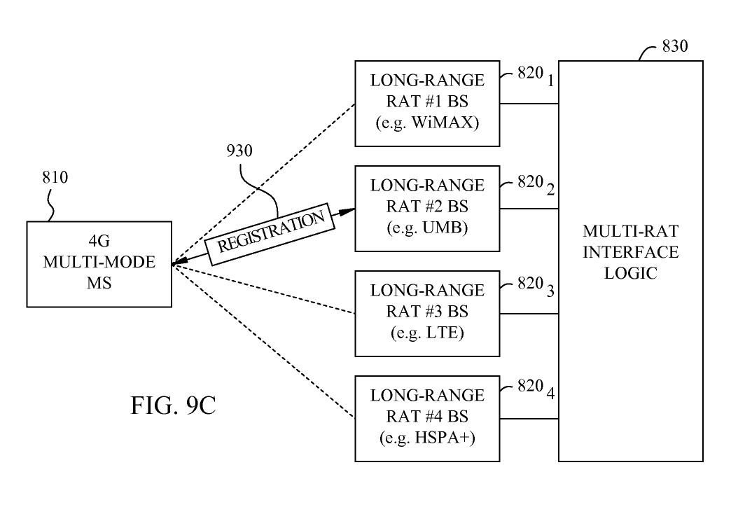

FIGS. 9A-9C illustrate how the network may prompt a multi-mode MS 810 to listen to a different RAT if network congestion on another RAT is detected. As illustrated in FIG. 9A, the MS 810 may have a connection to the first RAT BS 820₁ (e.g., an active WiMAX connection). However, the network may detect that there is congestion (e.g., via receipt of some type of network generated message 910) on the first RAT network.

In response, as illustrated in FIG. 9B, the network may instruct the MS 810 to listen for paging requests on a less congested network (e.g., RAT #2) via a message 920. Depending on the embodiment, the message 920 may be broadcast as a multi-mode message over all RATs supported by the MS or transmitted only over the congested RAT (as shown in the illustrated example). For some cases, the message 920 may be sent in response to the network observing that the MS 810 has responded to paging requests in the past on the congested network.

In response to the message 920, the MS 810 may proceed with operations to switch to the less congested RAT. For example, as illustrated in FIG. 9C, the MS 810 may proceed to send a registration request 930 to a base station of the less congested RAT network. In certain circumstances, however, the MS 810 may choose to disregard the message 920. For example, if the MS 810 is in a very low power mode, the paging method may be performed as part of the location service for tracking purposes. In such a case, the MS 810 may ignore the message request 920 and utilize a RAT which has a lower paging power consumption overhead than the RAT specified in the request 920.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as instructions or as one or more sets of instructions on a computer-readable medium or storage medium. A storage media may be any available media that can be accessed by a computer or by one or more processing devices. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a multi-mode mobile station, comprising:
transmitting a list of supported radio access technologies (RATs) supported by the mobile station;
establishing a connection with a first network via a first one of the RATs supported by the mobile station;
receiving, via the first connection, a multi-mode paging message indicating a paging request for the mobile station detected on a second network that supports a second one of the RATs supported by the mobile station; and
in response to the multi-mode paging message, establishing a connection with the second network via the second one of the RATs.

2. The method of claim 1, wherein at least one of the first and second RATs supported by the mobile station comprises a RAT in accordance with one or more standards of the Institute of Electrical and Electronics Engineers (IEEE) 802.16 family of standards.

3. The method of claim 2, wherein at least one of the first and second RATs supported by the mobile station comprises a code division multiple access (CDMA) RAT.

4. The method of claim 1, wherein transmitting the list of supported RATs comprises transmitting the list of supported RATs when establishing the first connection.

5. The method of claim 1, comprising establishing the connection with the first network via a first one of the RATs supported by the mobile station in response to a message indicating network congestion on a different network.

6. A method for wireless communications with a multi-mode mobile station, comprising:
receiving a list of at least first and second radio access technologies (RATs) supported by the mobile station; and
in response to detecting a paging request targeting the mobile station via a first one of the supported RATs, broadcasting multi-mode paging messages to the mobile station via the first and second RATs.

7. The method of claim 6, wherein receiving the list of RATs supported by the mobile station comprises receiving the list of RATs in a registration request.

8. The method of claim 6, wherein at least one of the first and second RATs supported by the mobile station comprises a RAT in accordance with one or more standards of the Institute of Electrical and Electronics Engineers (IEEE) 802.16 family of standards.

9. The method of claim 8, wherein at least one of the first and second RATs supported by the mobile station comprises a code division multiple access (CDMA) RAT.

10. The method of claim 6, further comprising transmitting a message to the mobile station requesting the mobile station switch from a first network connection via the first RAT to a second network connection via the second RAT.

11. A multi-mode mobile station, comprising:
logic for transmitting a list of supported radio access technologies (RATs) supported by the mobile station;
logic for establishing a connection with a first network via a first one of the RATs supported by the mobile station;
logic for receiving, via the first connection, a multi-mode paging message indicating a paging request for the mobile station detected on a second network that supports a second one of the RATs supported by the mobile station; and
logic for establishing a connection with the second network via the second one of the RATs in response to the multi-mode paging message.

12. The mobile station of claim 11, wherein at least one of the first and second RATs supported by the mobile station comprises a RAT in accordance with one or more standards of the Institute of Electrical and Electronics Engineers (IEEE) 802.16 family of standards.

13. The mobile station of claim 12, wherein at least one of the first and second RATs supported by the mobile station comprises a code division multiple access (CDMA) RAT.

14. The mobile station of claim 11, wherein the logic for transmitting the list of supported RATs is configured to transmit the list of supported RATs when establishing the first connection.

15. The mobile station of claim 11, further comprising logic for establishing the connection with the first network via a first one of the RATs supported by the mobile station in response to a message indicating network congestion on a different network.

16. A device for wireless communications with a multi-mode mobile station, comprising:
logic for receiving a list of at least first and second radio access technologies (RATs) supported by the mobile station; and
logic for broadcasting multi-mode paging messages to the mobile station via the first and second RATs in response to detecting a paging request targeting the mobile station via a first one of the supported RATs.

17. The device of claim 16, wherein the logic for receiving the list of RATs supported by the mobile station is configured to receive the list of RATs in a registration request.

18. The device of claim 16, wherein at least one of the first and second RATs supported by the mobile station comprises a RAT in accordance with one or more standards of the Institute of Electrical and Electronics Engineers (IEEE) 802.16 family of standards.

19. The device of claim 18, wherein at least one of the first and second RATs supported by the mobile station comprises a code division multiple access (CDMA) RAT.

20. The device of claim 16, further comprising logic for transmitting a message to the mobile station requesting the mobile station switch from a first network connection via the first RAT to a second network connection via the second RAT.

21. An apparatus for multi-mode wireless communications, comprising:
means for transmitting a list of supported radio access technologies (RATs) supported by the mobile station;
means for establishing a connection with a first network via a first one of the RATs supported by the mobile station;
means for receiving, via the first connection, a multi-mode paging message indicating a paging request for the mobile station detected on a second network that supports a second one of the RATs supported by the mobile station; and
means for establishing a connection with the second network via the second one of the RATs in response to the multi-mode paging message.

22. The mobile station of claim 21, wherein at least one of the first and second RATs supported by the mobile station comprises a RAT in accordance with one or more standards of the Institute of Electrical and Electronics Engineers (IEEE) 802.16 family of standards.

23. The mobile station of claim 22, wherein at least one of the first and second RATs supported by the mobile station comprises a code division multiple access (CDMA) RAT.

24. The mobile station of claim 21, wherein the means for transmitting the list of supported RATs is configured to transmit the list of supported RATs when establishing the first connection.

25. The mobile station of claim 21, further comprising means for establishing the connection with the first network via a first one of the RATs supported by the mobile station in response to a message indicating network congestion on a different network.

26. A device for wireless communications with a multi-mode mobile station, comprising:
means for receiving a list of at least first and second radio access technologies (RATs) supported by the mobile station; and
means for broadcasting multi-mode paging messages to the mobile station via the first and second RATs in response to detecting a paging request targeting the mobile station via a first one of the supported RATs.

27. The device of claim 26, wherein the means for receiving the list of RATs supported by the mobile station is configured to receive the list of RATs in a registration request.

28. The device of claim 26, wherein at least one of the first and second RATs supported by the mobile station comprises a RAT in accordance with one or more standards of the Institute of Electrical and Electronics Engineers (IEEE) 802.16 family of standards.

29. The device of claim 28, wherein at least one of the first and second RATs supported by the mobile station comprises a code division multiple access (CDMA) RAT.

30. The device of claim 26, further comprising means for transmitting a message to the mobile station requesting the mobile station switch from a first network connection via the first RAT to a second network connection via the second RAT.

31. A computer-readable medium containing a program which, when executed by a processor of a multi-mode mobile station, performs operations comprising:
transmitting a list of supported radio access technologies (RATs) supported by the mobile station;
establishing a connection with a first network via a first one of the RATs supported by the mobile station;
receiving, via the first connection, a multi-mode paging message indicating a paging request for the mobile station detected on a second network that supports a second one of the RATs supported by the mobile station; and
in response to the multi-mode paging message, establishing a connection with the second network via the second one of the RATs.

32. The computer-readable medium of claim 31, wherein at least one of the first and second RATs supported by the mobile station comprises a RAT in accordance with one or more standards of the Institute of Electrical and Electronics Engineers (IEEE) 802.16 family of standards.

33. The computer-readable medium of claim 32, wherein at least one of the first and second RATs supported by the mobile station comprises a code division multiple access (CDMA) RAT.

34. The computer-readable medium of claim 31, wherein transmitting the list of supported RATs comprises transmitting the list of supported RATs when establishing the first connection.

35. The computer-readable medium of claim 31, comprising establishing the connection with the first network via a first one of the RATs supported by the mobile station in response to a message indicating network congestion on a different network.

36. A computer-readable medium containing a program for wireless communications with a multi-mode mobile station which, when executed by a processor, performs operations comprising:
receiving a list of at least first and second radio access technologies (RATs) supported by the mobile station; and
in response to detecting a paging request targeting the mobile station via a first one of the supported RATs, broadcasting multi-mode paging messages to the mobile station via the first and second RATs.

37. The computer-readable medium of claim 36, wherein receiving the list of RATs supported by the mobile station comprises receiving the list of RATs in a registration request.

38. The computer-readable medium of claim 36, wherein at least one of the first and second RATs supported by the mobile station comprises a RAT in accordance with one or more standards of the Institute of Electrical and Electronics Engineers (IEEE) 802.16 family of standards.

39. The computer-readable medium of claim 38, wherein at least one of the first and second RATs supported by the mobile station comprises a code division multiple access (CDMA) RAT.

40. The computer-readable medium of claim 36, wherein the operations further comprise transmitting a message to the mobile station requesting the mobile station switch from a first network connection via the first RAT to a second network connection via the second RAT.
